(19) United States
(12) Patent Application Publication
(10) Pub. No.: US 2014/0140565 A1
(43) Pub. Date: May 22, 2014

(54) IN-EAR EARPHONE

(71) Applicant: Ozaki International Co., Ltd., New Taipei City (TW)

(72) Inventor: Keng-Yuan LIU, New Taipei City (TW)

(73) Assignee: Ozaki International Co., Ltd., New Taipei City (TW)

(21) Appl. No.: 14/049,455

(22) Filed: Oct. 9, 2013

(30) Foreign Application Priority Data
Nov. 21, 2012 (TW) 101222583

(51) Int. Cl. H04R 1/10

(52) U.S. Cl. CPC H04R 1/1091
USPC 381/380

(57) ABSTRACT

An in-ear earphone includes a shell body, a first electro-acoustic transducer and a second electro-acoustic transducer. The shell is hollow and has a first acoustic chamber and a second acoustic chamber in which the first acoustic chamber is connected with the second acoustic chamber. The volume of the Second acoustic chamber is smaller than that of the first acoustic chamber. The second acoustic chamber has an acoustic output opening disposed far from the first acoustic chamber. The first electro-acoustic transducer is assembled in the first acoustic chamber and the second electro-acoustic transducer is assembled in the second acoustic chamber.

### CROSS-REFERENCES TO RELATED APPLICATIONS

This non-provisional application claims priority under 35 U.S.C. §119(a) on Patent Application No. 101222583 filed in Taiwan, R.O.C. on Nov. 21, 2011, the entire contents of which are hereby incorporated by reference.

### BACKGROUND

1. Technical Field

The disclosure relates to an earphone, and particularly to an in-ear earphone.

2. Related Art

Due to the increasing development of technology, numerous electric devices are designed in a precise and miniaturized manner, including earphones. In order to create a stereo audio field and to have a good audio resolution for high-pitched sounds, middle-pitched sounds and low-pitched sounds, many manufacturers have attempted to place a number of speaker units in an earphone. For example, the KOSS company produced a conventional earphone with two speaker units (model number: KDE 250), wherein one of the two speaker units is responsible for the output of low-pitched sound, and another of the two speaker units is responsible for the output of high-pitched sound.

However, the size of the speaker unit corresponding to the low-pitched sound should be large enough to produce the low-pitched sound appropriately. Under this arrangement, neither the weight of the conventional earphone nor the volume of the conventional earphone can be reduced. Additionally, for an in-ear earphone, the volume of the in-ear earphone device affects the depth that the earphone inserts to the auditory canal. Therefore, how to decrease the volume and the weight of the earphone as well as to avoid the middle and high pitches affecting the low pitch is the topic that relevant manufacturers committed to research.

### SUMMARY

In view of this, an in-ear earphone is provided with a proper, weight, volume, and improved audio resolution among low-pitched sound, middle-pitched sound and high-pitched sound.

In an embodiment, the in-ear earphone includes a shell body, a first electro-acoustic transducer and a second electro-acoustic transducer.

The shell body is hollow and has a first acoustic chamber and a second acoustic chamber. The first acoustic chamber is connected with the second acoustic chamber. The volume of the second acoustic chamber is smaller than that of the first acoustic chamber. The second acoustic chamber has an acoustic output opening disposed far from the first acoustic chamber. The first electro-acoustic transducer is assembled in the first acoustic chamber, and the second electro-acoustic transducer is assembled in the second acoustic chamber.

The in-ear earphone according to the embodiments generates low frequency sound and middle, high frequency sound via the first electro-acoustic transducer and the second electro-acoustic transducer respectively. Further, since the alignment between the first electro-acoustic transducer and the second electro-acoustic transducer, acoustic output direction of the first electro-acoustic transducer is opposite to that of the second electro-acoustic transducer, so that the sound from the first electro-acoustic transducer and the sound from the second electro-acoustic transducer are arrived to the ear plug in different time. Consequently, the low frequency sound and the middle and high frequency do not interfere with each other, so that the in-ear earphone provides a high audio resolution.

The detailed features and advantages of the disclosure are described below in great detail through the following embodiments, the content of the detailed description is sufficient for those skilled in the art to understand the technical content of the embodiments and to implement the embodiments there accordingly. Based on the content of the specification, the claims, and the drawings, those skilled in the art can easily understand the relevant objectives and advantages of the embodiments.

### BRIEF DESCRIPTION OF THE DRAWINGS

The embodiments will become more fully understood from the detailed description given herein below for illustration only, and thus not limitative of the embodiments, wherein:

FIG. 1 is a perspective view of an in-ear earphone of an embodiment;

FIG. 2 is a cross-sectional view of FIG. 1 along line 2-2;

FIG. 3 is an exploded view of the in-ear earphone of an embodiment;

FIG. 4 is another exploded view of the in-ear earphone of an embodiment;

FIG. 5 is a schematic view of inner structures of a shell body of the in-ear earphone of an embodiment; and

FIG. 6 is a schematic view of acoustic output directions of a first electro-acoustic transducer and a second electro-acoustic transducer of the in-ear earphone of an embodiment.

### DETAILED DESCRIPTION

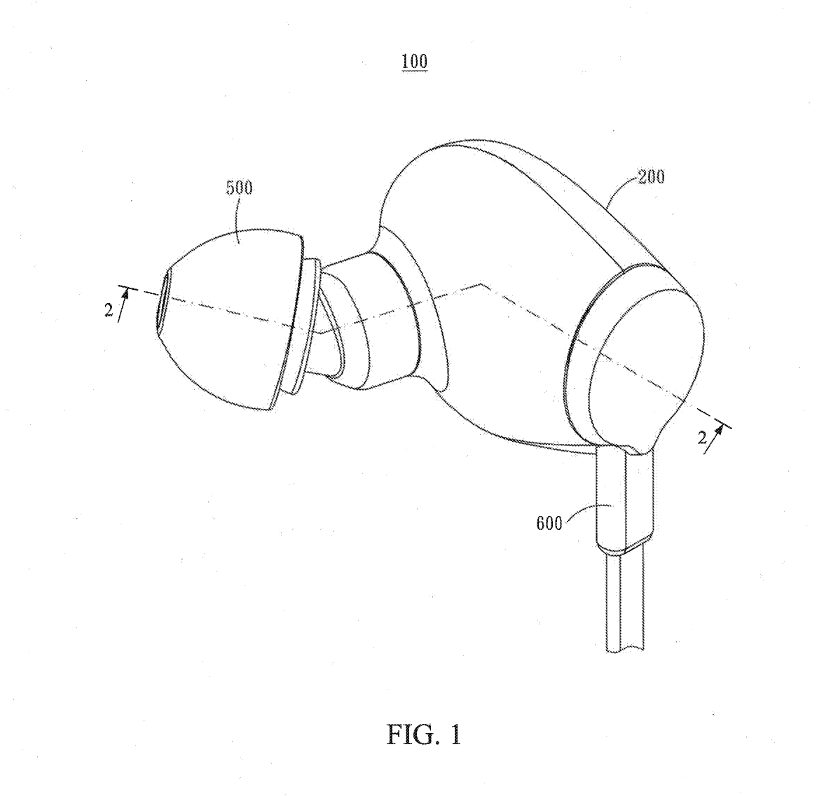

FIG. 1 is a perspective view of an in-ear earphone 100 of an embodiment.

As shown in FIG. 1, the in-ear earphone 100 has a shell body 200, an earplug 500 and an audio wire 600. The audio wire 600 is inserted into the shell body 200. The earplug 500 is sleeved on the shell body 200 so as to insert into the ear canals of a user.

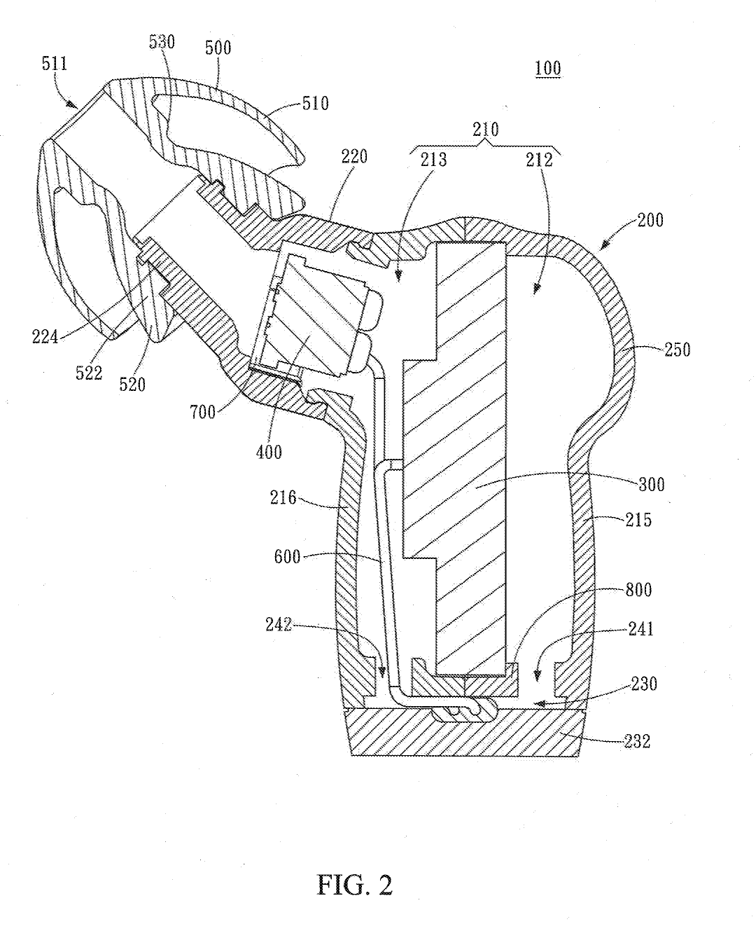

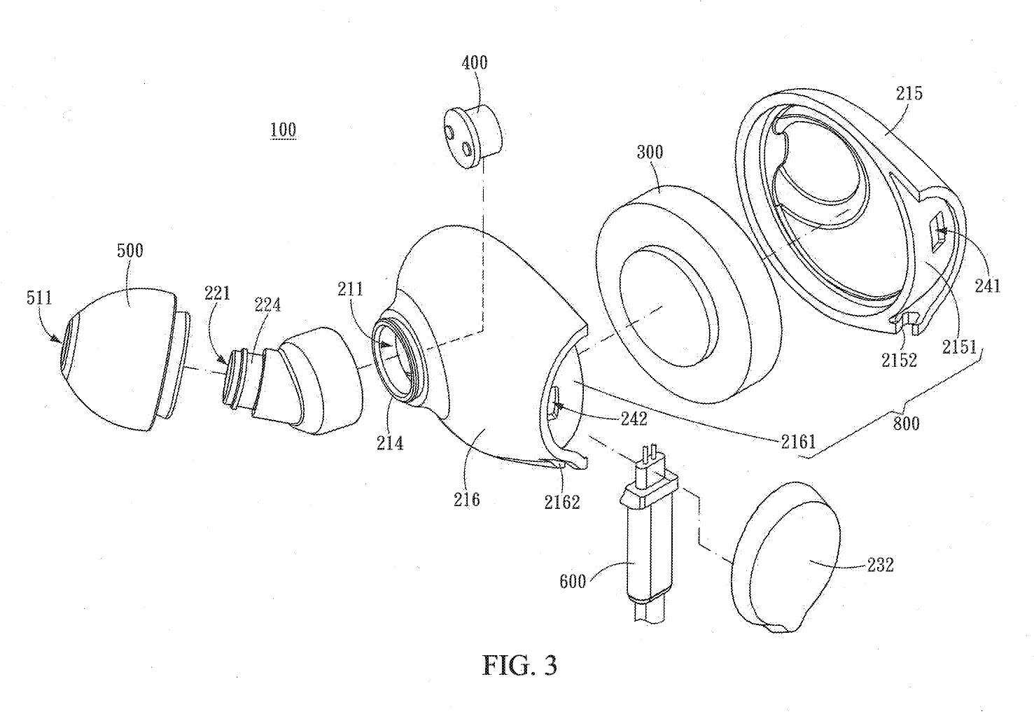

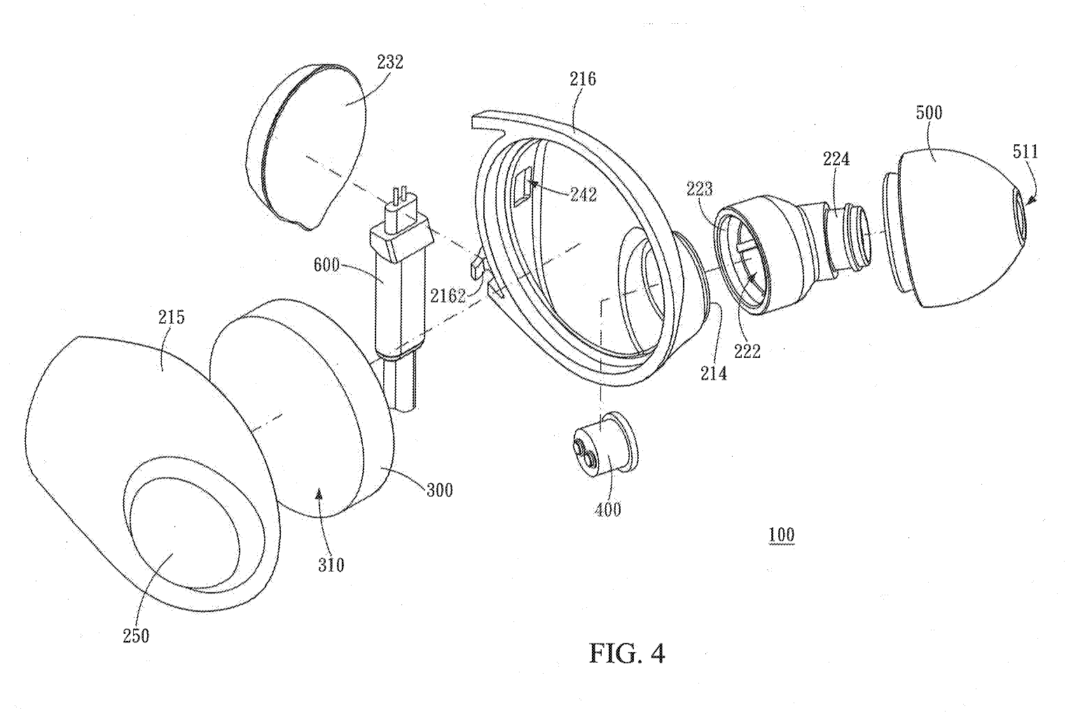

FIG. 2 is a cross-sectional view of FIG. 1 along line 2-2. FIG. 3 is an exploded view of the in-ear earphone 100 of an embodiment. FIG. 4 is another exploded view of the in-ear earphone 100 of an embodiment.

Please refer to FIGS. 2-4, in which the in-ear earphone 100 further has a first electro-acoustic transducer 300 and a second electro-acoustic transducer 400. The shell body 200 is hollow and has a first acoustic chamber 210 and a second acoustic chamber 220. The first acoustic chamber 210 is connected with the second acoustic chamber 220, and the volume of the second acoustic chamber 220 is smaller than that of the first acoustic chamber 210. The second acoustic chamber 220 has an acoustic output opening 221 disposed far from the first acoustic chamber 210. The first electro-acoustic transducer 300 is assembled in the first acoustic chamber 210. The second electro-acoustic transducer 400 is assembled in the second acoustic chamber 220.

Based on this, the sound output from the second electro-acoustic transducer 400 is transmitted out through the acoustic output opening 221 after being reflected by the second acoustic chamber 220 sound. Similarly, the sound output from the first electro-acoustic transducer 210 is transmitted out through the acoustic output opening 221 after being reflected by the fist acoustic chamber 210 and passed through the second acoustic chamber 220 sound.

Here, the size of the first electro-acoustic transducer 300 corresponds to the volume of the first acoustic chamber 210, and the size of the second electro-acoustic transducer 400 corresponds to the volume of the second acoustic chamber 220. In other words, the size of the first electro-acoustic transducer 300 is bigger than that of the second electro-acoustic transducer 400. Consequently, the first electro-acoustic transducer 300 is responsible for the generation of the low-pitched sound, and the second electro-acoustic transducer 400 is responsible for the generation of the middle-pitched sound and the high-pitched sound.

The first electro-acoustic transducer 300 and the second electro-acoustic transducer 400 are optionally selected as a moving coil transducer or a balanced armature transducer. The moving coil transducer has a magnet for forming a magnetic circuit, a yoke, and a vibrating plate and a sound coil that are regarded as a vibration system. The moving coil transducer is approximately formed as a circular plate, namely, a cylinder in which the height of the cylinder is smaller than the diameter of the cylinder. The balanced armature transducer has an armature motor approximately formed as a rectangular cuboid and an output opening connected to the armature motor. Here, the first electro-acoustic transducer 300 and the second acoustic transducer 400 are selected as the moving coil transducers for explanation.

The shell body 200 may be made of hard plastic materials, such as acrylonitrile butadiene styrene (ABS), wood or metals, such as aluminum, copper, steel, etc. or the alloys thereof.

The earplug 500 is made of synthetic resins, such as silica gel, rubber, or polypropylene.

As shown in FIG. 2, the first electro-acoustic transducer 300 is disposed on the middle cross-sectional plane of the first acoustic chamber 210 so as to divide the first acoustic chamber 210 into a reflecting space 212 and a transmitting space 213. The transmitting space 213 is located on one side of the first acoustic chamber 210 which is near to the second acoustic chamber 220, and the reflecting space 212 is located on another side of the first acoustic chamber 210.

Here, the in-ear earphone 100 has a channel connected with the reflecting space 212 and the transmitting space 213. In one embodiment, the shell body 200 further has a third acoustic chamber 230, a first transmitting opening 241 and a second transmitting opening 242. The first transmitting opening 241 is opened on the inner wall of the reflecting space 212. The second transmitting opening 242 is opened on the inner wall of the transmitting space 213. The third acoustic chamber 230 is located at one end of the first acoustic chamber 210 and is connected with the first acoustic chamber 210 via the first transmitting opening 241 and the second transmitting opening 242.

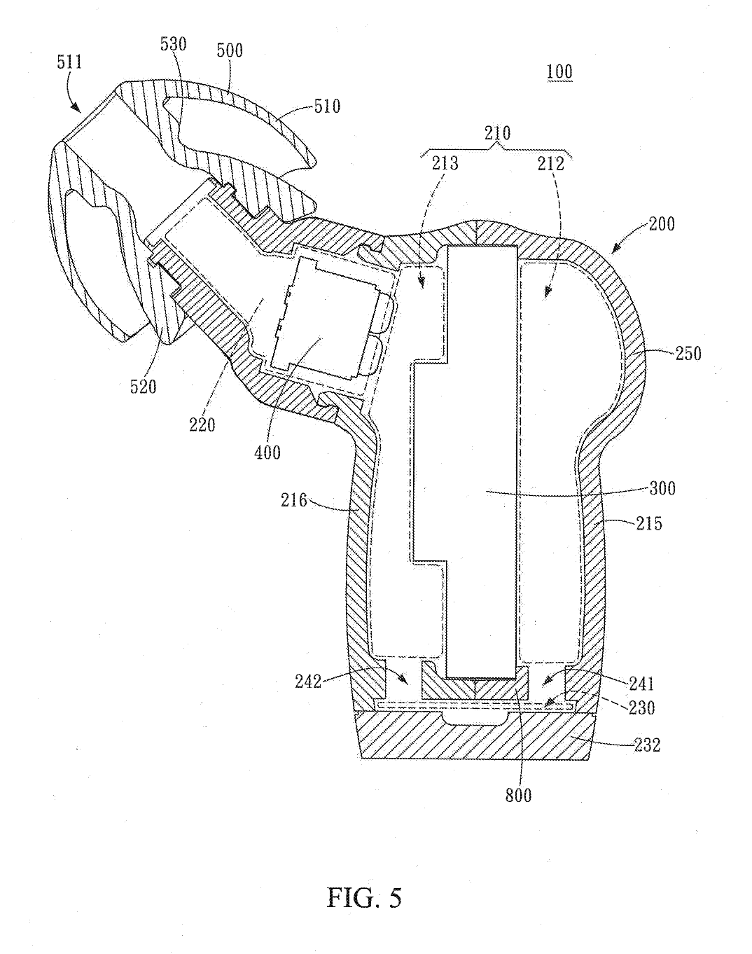

FIG. 5 is a schematic view of the inner structure of the shell body 200 of the in-ear earphone 100 of an embodiment, which is also a cross-sectional view of the FIG. 1 along line 2-2.

As shown in FIG. 5, the in-ear earphone 100 further has a separating wall 800. The separating wall 800 is formed by inwardly extending from the shell body 200. Based on this, the first acoustic chamber 210 and the second acoustic chamber 220 are located at one side of the separating wall 800, and the third acoustic chamber 230 is located at another side of the separating wall 800. The first transmitting opening 241 is disposed in the separating wall 800 near the reflecting space 212 and the second transmitting opening 242 is disposed in the separating wall 800 near the transmitting space 213.

Please refer to FIGS. 3-4, in which in one embodiment, the first acoustic chamber 210 is formed by correspondingly combining an upper cover 215 together with a lower cover 216. Here, the combing method can be, but not limited to, a thermal melting method, an adhering method, a buckling method, etc. A first separating wall 2151 is extended from the upper cover 215 toward the lower cover 216, and a second separating wall 2161 is extended from the lower cover 216 toward the upper cover 215. The first separating wall 2151 and the second separating wall 2161 are jointed together so as to divide the first acoustic chamber 210 from the third acoustic chamber 230. Here, the first transmitting opening 241 is opened on the first separating wall 2151, and the second transmitting opening 242 is opened on the second separating wall 2161.

As shown in FIGS. 3-4, the shell body 200 further has a end wall 232. The end wall 232 is connected with both the end of the upper cover 215 and that of the lower cover 216 so as to form the third acoustic chamber 230. Here, the combing method can be, but is not limited to, a thermal melting method, an adhering method, a buckling method, etc. A decorative pattern or text can be disposed on one side of the end wall 232 which is opposite to an interior of the third acoustic chamber 230, via, but not limited to, methods of imprinting, sticking, printing, engraving or so forth.

In one embodiment, the in-ear earphone 100 further has a filling member (not shown). The filling member encloses the first electro-acoustic transducer 300 around the periphery thereof so as to be disposed between the first electro-acoustic transducer 300 and the shell body 200. The filling member has at least one channel, so that the reflecting space 212 is connected with the transmitting space 213 via the channel. Based on this, the sound output from the first electro-acoustic transducer 300 is transmitted to the second acoustic chamber 220 via the filling member, but not the third acoustic chamber 230. Consequently, the first transmitting opening 241 and the second transmitting opening 242 are not needed in the in-ear earphone 100 in this embodiment.

In some embodiments, the transmitting routes and the reflecting angles of the sound output from the first electroacoustic transducer 300 are adjustable via changing the shape or the diameter of the channel between the reflecting space 212 and the transmitting space 213, so that the sound output performance of the first electro-acoustic transducer 300 can be modulated.

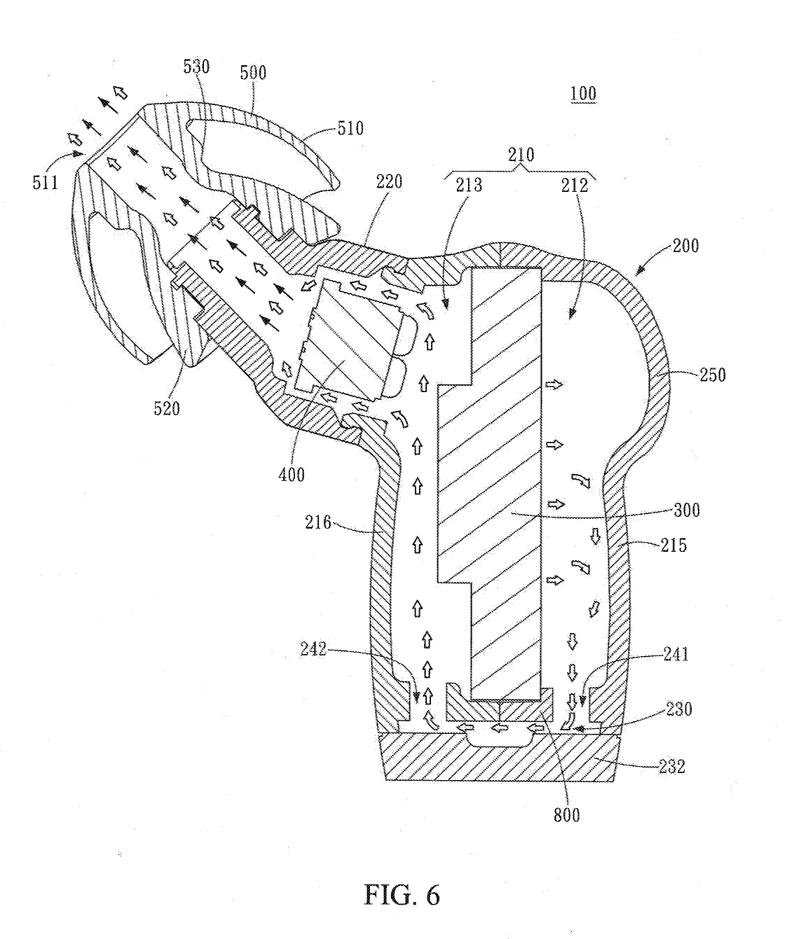

FIG. 6 is a schematic view of acoustic output directions of the first electro-acoustic transducer 300 and the second electro-acoustic transducer 400 of the in-ear earphone 100 of an embodiment.

As shown in FIG. 6, the acoustic output direction of the first electro-acoustic transducer 300 is far from the second electro-acoustic transducer 400. That is to say, the acoustic output plane 310 of the first electro-acoustic transducer 300 is at the side far from the second acoustic chamber 220. Based on this, the sound output from the first electro-acoustic transducer 300 is transmitted from the reflecting space 212 toward the third acoustic chamber 230 via the first transmitting opening 241 firstly, and is further transmitted from the third acoustic chamber 230 toward the second acoustic chamber 220 via the second transmitting opening 242 so as to be transmitted to the earplug 500 through the acoustic output opening 221.

Here, the in-ear earphone 100 further has a fastening member 700, as shown in FIG. 2. The fastening member 700 is disposed in the second acoustic chamber 220 so as to fasten the second electro-acoustic transducer 400. The fastening member 700 encloses the second electro-acoustic transducer 400 around the periphery thereof and has at least one through hole (not shown), connected with two sides of the second acoustic chamber 220, so that the sound output from the first electro-acoustic transducer 300 can be transmitted through the second acoustic chamber 220.

The fastening member 700 may be made of hard plastic materials, such as acrylonitrile butadiene styrene (ABS) or synthetic resins, such as silica gel, rubber or polypropylene.

As shown in FIG. 5, the acoustic output direction of the second electro-acoustic transducer 400 is far from the first electro-acoustic transducer 300. Consequently, the sound output from the second electro-acoustic transducer 400 is transmitted from the second acoustic chamber 220 to the earplug 500 through the acoustic output opening 221.

As shown in FIG. 5, because the transmitting route of the sound output from the first electro-acoustic transducer 300 is longer than that from the second electro-acoustic transducer 400, a longer transmitting time is necessary for the sound output from the first electro-acoustic transducer 300 to the acoustic output opening 241 as compared to the transmitting time for the sound output from the second electro-acoustic transducer 400 to the acoustic output opening 241. Therefore, the low pitch sound from the first electro-acoustic transducer 300 does not overlap with the middle pitch and high pitch sounds from the second electro-acoustic transducer 400 at the same time. Based on this, it is not necessary to enlarge the size of the first electro-acoustic transducer 300 for maintaining the performance of the sounds with high, middle and low pitches.

In one embodiment, the first acoustic chamber 210 is disposed between the second acoustic chamber 220 and the third acoustic chamber 230. That is to say, the second acoustic chamber 220 is disposed at the front side of the first acoustic chamber 210, and the third acoustic chamber 230 is disposed at the rear side of the first acoustic chamber 210. Based on this, within the limited volume inside the shell body 200, the length of the transmitting route of the sound from the first electro-acoustic transducer 300 is increased.

As shown in FIGS. 3-4, the upper cover 215 further has a first breach 2152, and the lower cover 216 further has a second breach 2162. The first breach 2152 and the second breach 2162 are combined to form a wire hole. In other words, the third acoustic chamber 230 includes the wire hole. The wire hole is opened on the inner wall of the third acoustic chamber 230, so that the audio wire 600 is inserted into the third acoustic chamber 230 through the wire hole.

As shown in FIG. 2, the audio wire 600 selectively passes through one of the first transmitting opening 241 and the second transmitting opening 242 so as to insert into the first acoustic chamber 210 and the second acoustic chamber 220, as well as to connect with the first electro-acoustic transducer 300 and the second electro-acoustic transducer 400. The audio wire 600 has an audio connector (not shown), so as to connect to an audio signal-generating device, such as a multimedia player, a smart phone, a computer or so forth. Based on this, the first electro-acoustic transducer 300 and the second electro-acoustic transducer 400 receive an audio signal from the audio signal-generating device to output corresponding sounds.

In one embodiment, the third acoustic chamber 230 further has another wire hole (not shown), opened on the first separating wall 2151 and/or the second separating wall 2161. The wire hole is configured for the audio wire 600 to pass through, so that the audio wire 600 is inserted into the first acoustic chamber 210 and the second acoustic chamber 220 via the third acoustic chamber 230. That is to say, the audio wire 600 is inserted into the first acoustic chamber 210 and the second acoustic chamber 220 via the sub wire hole of the third acoustic chamber 230, but not via the first transmitting opening 241 or the second transmitting opening 242.

Referring to FIGS. 3-4, the first acoustic chamber 210 has a first opening 211. The second acoustic chamber 220 is approximately formed as tube-shaped and has the acoustic output opening 221 and a second opening 222 and opposite to the acoustic output opening 221. The first opening 211 is connected with the second opening 222 so that the first acoustic chamber 210 is connected with the second acoustic chamber 220.

As shown in FIG. 3, the first opening 211 of the first acoustic chamber 210 is radially protruded outward so as to form a first protrusion 214. A first groove 223 is formed adjacent to the second opening 222 of the second acoustic chamber 220 so as to engage with the first protrusion 214. Here, the first opening 211 and the second opening 222 is connected with each other in an engaging manner, but embodiments are not limited thereto, the first opening 211 and the second opening 222 can connect with each other via adhering, locking or so forth.

As shown in FIG. 2, the earplug 500 has an outer mushroom portion 510, an inner mushroom portion 520 and an acoustic tube 530. The outer mushroom portion 510 has a third opening 511 in the center thereof. The inner mushroom portion 520 has a fourth opening 521 in the center thereof. The third opening 511 and the fourth opening 521 are connected to two ends of the acoustic tube 530 respectively. The inner mushroom portion 520 is sleeved onto the acoustic output opening 221 of the second acoustic chamber 220.

Here, the inner mushroom portion 520 is protruded inward so as to form a second protrusion 522. The acoustic output opening 221 of the second acoustic chamber 220 has a second groove 224 recessed on a periphery thereof, so that the second protrusion 522 is engaged with the second groove 224.

Please refer to FIGS. 2-4, in which the shell body 200 further has a supporting member 250. The supporting member 250 is substantially formed by bulged outwardly the outer wall of the first acoustic chamber 210 and is disposed far from the second acoustic chamber 220. In other words, the supporting member 250 and the second acoustic chamber 220 is located at the front side of the first acoustic chamber 210, and the third acoustic chamber 230 is located at the rear side of the first acoustic chamber 210. Based on this, upon wearing the in-ear earphone 100, the supporting member 250 is leaned against the auricle of the user so as to improve the stability for wearing the in-ear earphone 100.

Here, the supporting member 250 is separable from the outer wall of the first acoustic chamber 210. That is to say, the supporting member 250 is detachably connected to the outer wall of the first acoustic chamber 210 via methods of engaging, locking, threading or so forth. Based on this, the user could choose a proper sized supporting member 250 according to the shape and the size of the auricle of the user.

Based on the above, the in-ear earphone 100 according to the disclosure generates low pitch sound and middle, high pitch sounds via the first electro-acoustic transducer 300 and the second electro-acoustic transducer 400 respectively. Further, since the alignment between the first electro-acoustic transducer 300 and the second electro-acoustic transducer 400, acoustic output direction of the first electro-acoustic transducer 300 is opposite to that of the second electro-acoustic transducer 400, so that the sound output from the first electro-acoustic transducer 300 and the sound output from the second electroacoustic transducer 400 arrive to the earplug 500 in different times. Therefore, the low pitch sound and the middle, high pitch sound do not interfere with each other, so that the in-ear earphone 100 provides a high audio resolution.

While the disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. An in-ear earphone, comprising:
a shell body, being hollow and having a first sound chamber and a second acoustic chamber, wherein the second acoustic chamber is connected with the first acoustic chamber and has an acoustic output opening disposed far from the first acoustic chamber, wherein a volume of the second acoustic chamber is smaller than a volume of the first acoustic chamber;
a first electro-acoustic transducer, assembled in the first acoustic chamber; and
a second electro-acoustic transducer, assembled in the second acoustic chamber.

2. The in-ear earphone according to claim 1, wherein an acoustic output direction of the first electro-acoustic transducer is far from the second electro-acoustic transducer.

3. The in-ear earphone according to claim 1, wherein an acoustic output direction of the second electro-acoustic transducer is far from the first electro-acoustic transducer.

4. The in-ear earphone according to claim 1, wherein the first electro-acoustic transducer divides the first acoustic chamber into a reflecting space and a transmitting space, and the transmitting space is located near to the second acoustic chamber.

5. The in-ear earphone according to claim 4, further comprising at least one channel connected with the reflecting space and the transmitting space.

6. The in-ear earphone according to claim 4, further comprising a filling member enclosing the first electro-acoustic transducer around the periphery thereof so as to be disposed between the first electro-acoustic transducer and the shell body, and the filling member has at least one channel so that the reflecting space is connected with the transmitting space via the channel.

7. The in-ear earphone according to claim 4, further comprising a separating wall inwardly extending from the shell body, wherein the first acoustic chamber and the second acoustic chamber are located at one side of the separating wall, the shell body further has a third acoustic chamber located at another side of the separating wall, and the third acoustic chamber has a first transmitting opening disposed in the separating wall near the reflecting space and a second transmitting opening disposed in the separating wall near the transmitting space.

8. The in-ear earphone according to claim 7, wherein the first acoustic chamber is disposed between the second acoustic chamber and the third acoustic chamber.

9. The in-ear earphone according to claim 7, wherein the third acoustic chamber has a wire hole located in the shell.

10. The in-ear earphone according to claim 9, wherein an audio wire selectively passes through the first transmitting opening or the second transmitting opening and passes through the wire hole, so that the audio wire is electrically connected with the first electro-acoustic transducer and the second electro-acoustic transducer respectively.

11. The in-ear earphone according to claim 1, further comprising a fastening member enclosing the second electro-acoustic transducer around the periphery thereof, and the fastening member has at least one through hole connected with two sides of the second acoustic chamber.

12. The in-ear earphone according to claim 1, wherein the first acoustic chamber has an upper cover with a first separating wall extending toward the lower cover, and a lower cover with a second separating wall extending cover toward the upper cover, wherein the first separating wall and the second separating wall are jointed together.

13. The in-ear earphone according to claim 12, further comprising a end wall connected with both the end of the upper cover and that of the lower cover so as to form a third acoustic chamber.

14. The in-ear earphone according to claim 13, wherein the end wall has a decorative pattern or text disposed opposite to an interior of the third acoustic chamber.

15. The in-ear earphone according to claim 1, wherein the first acoustic chamber has a first opening, the second acoustic chamber has a second opening opposite to the acoustic output opening, and the first opening is connected with the second opening.

16. The in-ear earphone according to claim 15, wherein the first opening of the first acoustic chamber is radially protruded outward so as to form a first protrusion, and a first groove is formed adjacent to the second opening of the second acoustic chamber so as to engage with the first protrusion.

17. The in-ear earphone according to claim 15, further comprising an ear plug having an outer mushroom portion with a third opening in the center thereof, an inner mushroom portion with a fourth opening in the center thereof and an acoustic tube with two ends to connect between the third opening and the fourth opening respectively, wherein the inner mushroom portion is sleeved onto the acoustic output opening of the second acoustic chamber.

18. The in-ear earphone according to claim 17, wherein the inner mushroom portion is protruded inward so as to form a second protrusion, and the acoustic output opening of the second acoustic chamber has a second groove recessed on a periphery thereof, so that the second protrusion is engaged with the second groove.

19. The in-ear earphone according to claim 1, wherein the shell body has a supporting member bulged outward from the outer wall of the first acoustic chamber and disposed far from the second acoustic chamber.

20. The in-ear earphone according to claim 19, wherein the supporting member is separable from the outer wall of the first acoustic chamber.
